(19) United States
(12) Patent Application Publication
(10) Pub. No.: US 2023/0054475 A1
(43) Pub. Date: Feb. 23, 2023

(54) COOKING DEVICE WITH SELECTIVE HEATING

(71) Applicant: X Development LLC, Mountain View, CA (US)

(72) Inventors: Alexander Martin Zoellner, Los Gatos, CA (US); Joel Emilio Bregman Segre, Oakland, CA (US); Matthew Dixon Eisaman, Port Jefferson, NY (US); Peter Christian Norgaard, Mountain View, CA (US); Thomas Peter Hunt, Oakland, CA (US)

(21) Appl. No.: 17/891,338

(22) Filed: Aug. 19, 2022

Related U.S. Application Data
(60) Provisional application No. 63/235,954, filed on Aug. 23, 2021.

(51) Int. Cl. H05B 6/68; H05B 6/70; H05B 6/72; H05B 6/64; H01P 3/127

(52) U.S. Cl. CPC H05B 6/687; H05B 6/707; H05B 6/72; H05B 6/645; H05B 6/6464; H01P 3/127

(57) ABSTRACT

Methods, systems, and apparatus, including computer programs encoded on computer-storage media, for selective heating. In some implementations, a cooking device for selective heating includes a cavity, one or more waveguides coupled to the cavity, a power generation means coupled to the one or more waveguides and configured to generate an incident power, one or more apertures between the cavity and the one or more waveguides, and a controller configured to control one or more of the power generation means, the apertures, or a cavity geometry. A cooking device cavity geometry can be dynamically configurable. The cooking device can include one or more sensors coupled to the cavity.

### CROSS REFERENCE TO RELATED APPLICATION

This application claims the benefit of U.S. Provisional Application No. 63/235,954, filed Aug. 23, 2021, the contents of which are incorporated by reference herein.

### TECHNICAL FIELD

This specification relates generally to cooking devices, and more particularly to a cooking device that facilitates selective heating of food.

### BACKGROUND

Conventional cooking devices, such as microwave ovens, include a cavity for receiving a load to be heated. Generally, electromagnetic energy is absorbed by the food depending on the frequency implemented and the dielectric properties of the food. Microwave ovens rely on a magnetron to generate high power RF (Radio Frequency) electromagnetic energy that interacts with the microwave cavity to create patterns of standing waves and transfer energy to the load. The magnetron is an uncontrolled oscillator without feedback mechanisms to monitor or set the frequency.

Although conventional microwave ovens deliver rapid heating to the food, the distribution of heat tends to be highly non-uniform with cold and hot spots, resulting in food with overcooked dehydrated parts, and cold or raw parts. Power delivery tends to be highly variable as the system heats up. As a consequence, microwave ovens heat loads to variable efficiency. Further, due to the open-loop nature of the magnetron-based microwave systems, conventional ovens typically are only able to deliver an approximate energy output that decreases over time, as they typically cannot adapt to irradiated energy and energy reflected from the food into the cavity as the food is heated.

Further, conventional microwave ovens typically are unable to adjust parameters such as phase, frequency, and output power, which leads to large swings in efficiency when the load volume, distribution, and number of food items change. Further, conventional microwaves typically create standing waves inside a cavity that provide too much energy to the food in hot spots and too little in cold spots. Overall, conventional microwave ovens typically suffer from poor heating process control. Accordingly, there exists a growing need for improved microwave ovens capable of delivering energy to the food in a precise, uniform, and controllable manner.

### SUMMARY

This specification describes a cooking device with configurable geometry that facilitates selective and local heating of food.

According to a first aspect there is provided a cooking device that includes a cavity, one or more waveguides coupled to the cavity, a power generation means coupled to the one or more waveguides and configured to generate an incident power, one or more pixelated elements disposed between the cavity and the one or more waveguides, where the pixelated elements are configured to modulate an amount of the incident power that is transmitted between the cavity and the waveguide, and a controller configured to control the power generation means and the pixelated elements in such a way so as to optimize a performance of the cooking device.

Particular embodiments of the subject matter described in this specification can be implemented so as to realize one or more of the following advantages.

The cooking device described in this specification harnesses recent advances in solid-state RF technology, optimizes efficiency and power of energy transfer to eliminate cold and hot spots, and facilitates localized, selective, and controllable near-field coupling of energy to the food.

The cooking device of the present disclosure employs different cavity geometries and waveguide configurations that can facilitate localized energy coupling between the cooking device and the food, thereby virtually eliminating undesirable cold and hot spots and ensuring uniform distribution of energy throughout the food. Furthermore, through different configurations of “pixels”, e.g., controllable absorbing, transmissive, and/or reflective elements distributed within the cooking device, the energy can be delivered to the food in a highly-customizable and controllable manner. The cooking device described in this specification is able to provide consistent performance during the varied load conditions required for cooking and optimize the cooking process.

One innovative aspect of the subject matter described in this specification is embodied in a cooking device that includes a cavity; one or more waveguides coupled to the cavity; a power generation means coupled to the one or more waveguides and configured to generate an incident power; one or more apertures disposed between the cavity and the one or more waveguides, wherein the apertures are configured to modulate an amount of the incident power that is transmitted between the cavity and the waveguide; and a controller configured to control the power generation means and the apertures.

Other implementations of this and other aspects include corresponding systems, apparatus, methods, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The foregoing and other embodiments can each optionally include one or more of the following features, alone or in combination. For instance, in some implementations, the apertures comprise physical elements for opening and closing a path between the cavity and the one or more waveguides.

In some implementations, the physical elements comprise field-effect transistors (FETs).

In some implementations, shield properties of the apertures are modulated by an application or removal of voltage.

In some implementations, the physical elements include a physical disk having a pattern of open holes configured to dynamically open or close one or more apertures.

In some implementations, the cooking device includes an absorber coupled to the one or more waveguides configured to transform radiation of the incident power into electric energy.

In some implementations, the absorber includes one or more of antennas, rectifiers, or circuits.

In some implementations, the absorber includes a network of fluid channels.

In some implementations, the one or more waveguides are coupled to the cavity on a single side of the cavity.

In some implementations, the one or more waveguides are coupled to the cavity on two or more sides of the cavity.

In some implementations, the two or more sides include a first side and a second side, wherein the first side and the second side each lie in a plane and the planes are substantially parallel to one another.

In some implementations, the incident power comprises microwave radiation.

In some implementations, the microwave radiation includes multiple electromagnetic frequencies.

In some implementations, the multiple electromagnetic frequencies are configured to generate a beat frequency and to facilitate coupling of energy to an item to be heated located in the cavity.

Another innovative aspect of the subject matter described in this specification is embodied in a method that includes obtaining, by a computing device coupled to a cooking device, sensor data from one or more sensors of the cooking device; generating, using the sensor data, a signal configured to activate one or more apertures of the cooking device, wherein each aperture of the one or more apertures is configured to modulate energy transfer from a first cavity to a second cavity; and sending the signal to the one or more apertures of the cooking device.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The foregoing and other embodiments can each optionally include one or more of the following features, alone or in combination. For instance, in some implementations, the first cavity is coupled to a power source generating radiation.

In some implementations, the sensor data represents data of an item to be heated in the cooking device.

In some implementations, the one or more sensors of the cooking device include one or more of a weight sensor or thermal sensor.

In some implementations, the apertures are disposed between the first cavity and the second cavity along one or more waveguides.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1A illustrates an example cooking device with an upper cavity.

FIG. 1B illustrates an example cooking device with upper and lower cavities.

FIG. 1C illustrates an example cooking device with upper and lower cavities.

FIG. 1D illustrates an example cooking device with upper and lower cavities.

FIG. 2A illustrates an example cooking device with upper and lower cavities.

FIG. 2B illustrates an example cooking device with upper and lower cavities.

FIG. 3A illustrates an example cooking device with a parallel waveguide.

FIG. 3B illustrates an example cooking device with a parallel waveguide.

FIG. 4A illustrates an example cooking device with a multipass waveguide.

FIG. 4B illustrates an example cooking device with a multipass waveguide.

Like reference numbers and designations in the various drawings indicate like elements.

### DETAILED DESCRIPTION

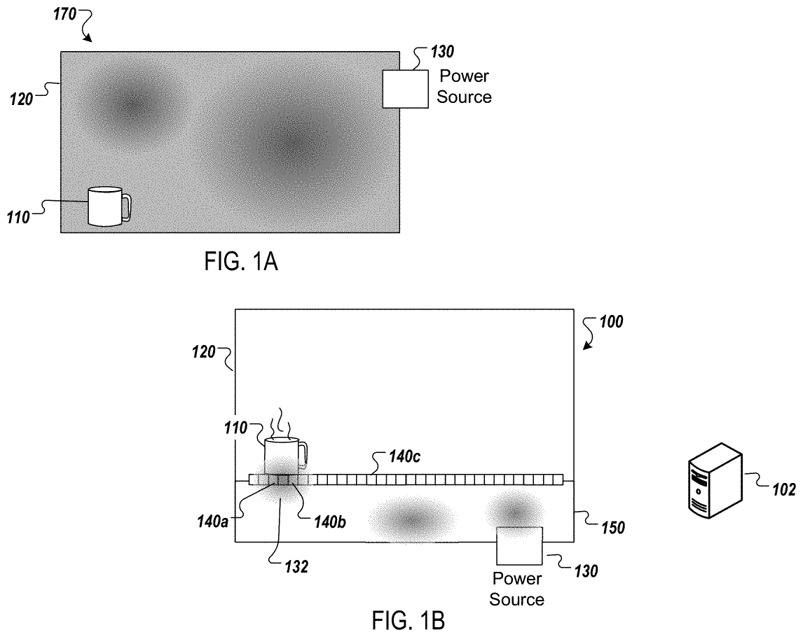

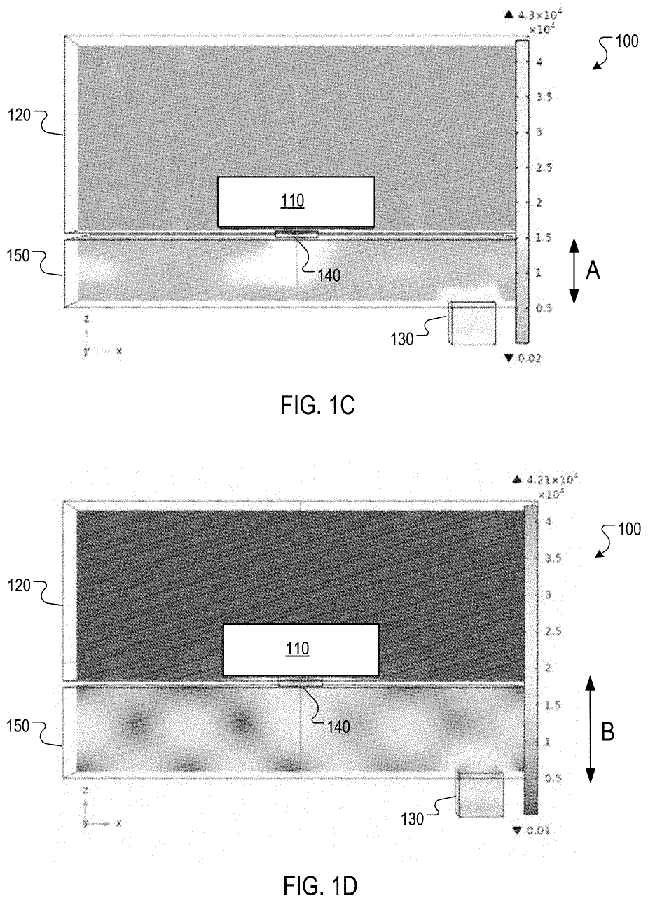

FIG. 1A illustrates an example cooking device 170 with an upper cavity. The upper cavity is filled with energy shown graphically as gradated shading from power source 130. FIG. 1A shows the energy produced by the power source 130 filling heating chamber 120, acting as an upper cavity, with some areas heating more than others depending on the wave interactions of energy emitted from the power source 130. In general, areas heated more than others can change depending on a power level of the power source 130, the power source 130, or aspects of a heated item 110 (e.g., a mug, food, among others) in the heating chamber 120 being heated.

FIG. 1B improves on the heating of FIG. 1A by, in part, localizing the energy to a position of the item 110. FIG. 1B illustrates an example cooking device 100 with upper and lower cavities. A lower cavity 150 of the device 100 is connected to the power source 130. As described in regard to FIG. 1A, the power source 130 fills an area with energy (e.g., microwave radiation). Instead of filling the heating chamber 120 shown in FIG. 1B with energy, the power source 130 fills the lower cavity 150 with energy. The energy (e.g., energy region 132) is then released by one or more apertures (e.g., apertures 140a-c) localized on the item 110 for efficient heating with reduced temperatures differences in the item 110.

In some implementations, the apertures 140a-c are physical holes that allow energy to pass through. For example, the aperture 140a can be defined by a hole through a material that separates the heating chamber 120 from the lower cavity 150. In some implementations, the apertures 140a-c are configurable to allow energy to flow based on an electronic signal. For example, the apertures 140a-c can be connected to one or more computing devices (e.g., computer 102). A computing device can determine one or more apertures through which to allow energy so as to configure heating of one or more items in the heating chamber 120.

In some implementations, the computing device 102 is communicably connected to the cooking device 100. For example, the computing device 102 can be connected with the cooking device 100 using one or more wired or wireless connections. In some implementations, the computing device 102 receives input data from one or more sensors of the cooking device 100. For example, a weight sensor of the cooking device 100 can send a signal to the computing device 102 indicating weight at a position in the heating chamber 120. In response to receiving the weight sensor data, the computing device 102 can determine that the position in the heating chamber 120 matches, or is within a matching threshold, of a location of the apertures 140a and 140b. The computing device 102 can determine to allow energy to pass through apertures 140a and 140b. In some cases, the computing device 102 determines not to allow energy to pass through aperture 140c or other apertures because no weight was sensed in a location within a threshold distance of the location of the aperture 140c. In general, the computing device 102 can determine any number of apertures to open using sensor data provided by one or more sensors of the cooking device 100.

In some implementations, the computing device 102 sends a signal to the apertures 140a and 140b. The signal can be configured to allow energy to pass through from the lower cavity 150 to the heating chamber 120. In some implementations, a signal configured to allow energy to pass through from the lower cavity 150 to the heating chamber 120 includes one or more instructions. For example, the signal can include an instruction to activate a physical element of, or connected to, an aperture. The physical element can activate to create a physical opening between the lower cavity 150 and the heating chamber 120. The physical element can activate to create a physical barrier between the lower cavity 150 and the heating chamber 120. The physical element can include a latch or sliding door to control the passing of energy between the lower cavity 150 and the heating chamber 120. The physical element can include a material that is stationary but can change an ability to allow or not allow energy through. Example materials can include a material that, when activated with an electronic signal, changes structural features to impede, or allow, transmission of energy (e.g., microwaves).

Compared to a heating device that fills an entire heating cavity with energy (e.g., device 170), the heating device 100 can decrease energy usage, increase heating efficiency, and decrease temperature differences in the heated item 110. In some implementations, the computing device 102 adjusts one or more apertures during a heating of the item 110. Adjustments can include activating, or partially activating, an element of one or more apertures allow a full amount or partial amount of energy from the power source 130 into the heating chamber 120.

In some implementations, the computing device 102 obtains sensor data from the heating device 100 including thermal data. The thermal data can include thermal data of the item 110. The computing device 102 can adjust apertures (e.g., the apertures 140a-c) to decrease energy applied to an area that is more hot than another area of the item 110. The computing device 102 can adjust apertures to increase energy applied to an area that is less hot than another area of the item 110. The computing device 102 can adjust apertures while the item 110 is being heated.

In the examples of FIG. 1A and FIG. 1B, a mug of liquid (e.g., coffee, tea) 110 is being heated. In general, any item or items with any geometry can be heated as discussed herein. Such items can be referred to generally as a block (e.g., block 110 of FIG. 1C). The size or shape of the item can affect what apertures are activated to provide energy to the item. For example, the computing device 102 can obtain sensor data from the heating device 100 indicating multiple items in different areas of the heating chamber 120. The computing device 102 can obtain sensor data from the heating device 100 indicating a single item with different weight in different areas of the heating chamber 120. The computing device 102 can adjust aperture activations to allow energy in the lower cavity 150 to pass through to the areas where there are items to be heated or more energy where there is more weight or where items are cooler. Sensor data can include weight data from weight sensors, thermal data from thermal sensors, among others. Sensors can be connected to a body of the heating device 100 (e.g., inside the heating chamber 120, inside the lower cavity 150, on one or more of the apertures, among others). Both FIG. 1A and FIG. 1B represent cross sectional views of a cooking device.

FIG. 1C shows an example of the cooking device 100 with a configurable geometry. In some implementations, a computing device, such as the computing device 102, configures geometry for a particular item to be heated. For example, cooking particular items (e.g., larger or heavier items) with a larger lower cavity portion can result in more even and efficient heating. Cooking particular items with a smaller lower cavity portion can result in more even and efficient heating. A computing device coupled to a cooking device (e.g., the cooking device 100) can adjust a cavity size during, before, or after heating to optimize heating of an item.

The cooking device 100 includes a main heating chamber 120 (e.g., an upper cavity) where the load to be heated, e.g., food, represented as a block 110, can be placed. The cooking device 100 further includes the lower cavity 150 (e.g., a resonant cavity) that is coupled to the power source 130 including a port and a power generation means which can be, e.g., a solid-state RF power amplifier, or any other appropriate power generation means. The energy generated by the power generation means can be substantially contained in the lower cavity 150. The cooking device further includes an aperture 140 (e.g., the apertures 140a-c) that facilitates the transfer of energy from the lower cavity 150 into the upper cavity 120, e.g., into the food 110. The cooking device 100 can include one or multiple apertures 140. Placing the food 110 in close proximity to, and above, the apertures 140, can facilitate focusing the energy onto a substantially small region (or multiple small regions) on the food 110, thereby facilitating localized and selective heating of the food 110 in a controllable and customizable manner.

The cooking device 100 can have any appropriate dimensions. In one example, the dimensions can be 17.5 inches in width, 16.5 inches in depth, and 10.25 inches in height. The cooking device 100 can operate in any appropriate frequency range, e.g., 2.20 to 3.30 GHz. A port of the power source 130 can be set on the lower cavity 150 with any appropriate mode, e.g., TE mode 10.

The one or more apertures 140 can be implemented in any variety of ways. In one example, the apertures 140 can be “pixels”, e.g., individual elements that are arranged in a pattern between the upper cavity 120 and the lower cavity 150. The pixels can be physically or electrically activated, automatically or on demand. In some implementations, arranging the apertures 140 in a substantially close proximity to the food 110 can facilitate near-field coupling of energy from the lower cavity 150 and to the food 110. This, in turn, can reduce the number or amount of power generation means that can be required to efficiently couple the energy to the food 110 and reduce the overall cost of the cooking device 100.

In some implementations, the apertures 140 (e.g., pixels) can shield energy (e.g., radiation) from the food, and can be implemented as materials that have absorbing and/or reflective properties. Individual pixels can be selectively activated/deactivated by, e.g., physically opening/closing the pixels, moving the pixels, or electrically activating/deactivating pixels. Furthermore, the pixels can be modulated electrically, or otherwise, to facilitate a gradual change in absorptive, reflective, or transmissive, properties of the pixels.

In some implementations, the aperture 140 (or multiple apertures) can be provided in a reflector plate that can be disposed in the x-y plane between the upper cavity 120 and the lower cavity 150. The reflector plate can have any appropriate thickness and dimensions, e.g., the thickness and dimensions can be chosen according to the dimensions of the lower cavity 150, or any other aspect of the cooking device 100. In one example, the reflector (and the aperture 140) can be disposed at a first height A with respect to the upper cavity 120. In another example, as shown in FIG. 1D, the height B can be larger than the height A. The reflector height can have an influence on the energy coupling between the lower cavity 150 and the food 110.

In some implementations, the cooking device 100 can further include an absorber configured to absorb reflected energy and to transform it into electrical energy. For example, the absorbed energy can be used for steam generation through, e.g., a network of fluid channels. In another example, the absorber can include, e.g., antennas, rectifiers, or other circuits, that can transform the absorbed energy back into electric energy. In this way, the efficiency of the cooking device 100 can be improved to, e.g., 90%, leaving only a small thermal load on the cooking device 100. The cooking device 100 can further include a curved LCD (Liquid Crystal Display) reflector that can be configured to direct the reflected energy into the absorber.

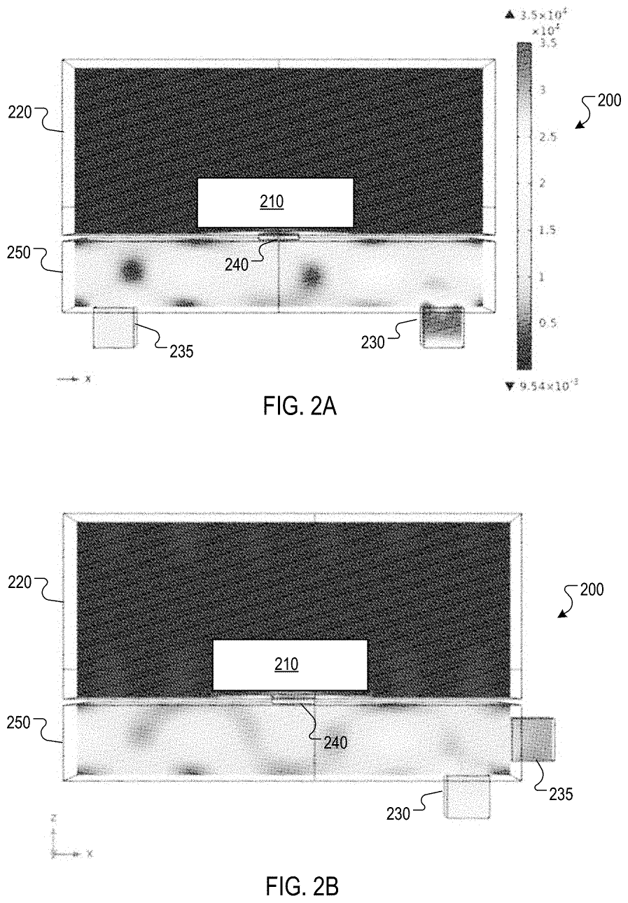

FIG. 2A shows an example cooking device 200 having substantially the same components as the cooking device 100 shown in FIGS. 1C and 1D, e.g., an upper cavity 220, a lower cavity 250, food 210, a port 230, an aperture 240, while additionally including a second port 235 that is passive and is configured to act as a dump of energy/power. In some implementations, the second port 235 can be coupled to an absorber (e.g., the absorber described above) for electrical and/or steam energy generation. As shown in FIG. 2A, the second port 235 can be placed symmetrically with the first port 230 in the x-y plane. In another example, the port can be placed in the y-z plane, as shown in FIG. 2B. Placing the second port 235 in the y-z plane can increase the coupling of energy to the food 210.

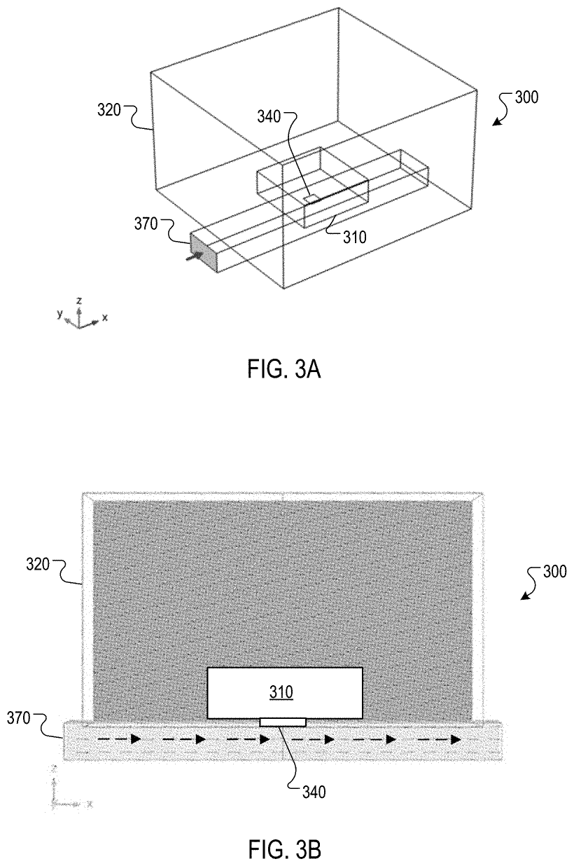

FIG. 3A shows an example cooking device 300 having an upper cavity 320, food 310, and aperture 340, but instead of having a lower cavity, as described above with reference to FIGS. 1B, 1C, 1D, 2A, and 2B, the cooking device 300 includes a parallel waveguide 370, or multiple parallel waveguides. The waveguide 370 includes an input port, indicated by the arrow in FIG. 3A, while symmetrically opposite end of the waveguide 370 with respect to the input port, includes an output port (e.g., a dump of energy/power). The energy can couple from the waveguide 370, through one or more apertures 340, to the food 310. Further, the energy can propagate from the input port, through the waveguide 370, and towards the output port, as indicated by the arrows in FIG. 3B.

By way of example, if the aperture 340 has a substantially square geometry, having dimensions of 2 inches, approximately 27% of power can be dissipated through a localized region on the food 310 facilitating near-field coupling of energy to the food 310, while the remaining power can exit through the output port of the waveguide 370.

In all implementations described in this specification, multiple parameters of the cooking device can be varied in order to optimize the coupling of energy to the food, such as, e.g., the height of the food placement with respect to the aperture, the materials from which the cooking device is made, the size, shape, and location of the aperture, the frequency of the power generation means, the size of the waveguide, the placement of the ports, and any other appropriate parameters. In some implementations, apertures are placed along the waveguide 370 to enable heating at multiple points along the waveguide 370. For example, similar to the apertures 140a-c, the device 300 can include multiple apertures between the waveguide 370 and the upper cavity 320. As described, the apertures can be controlled by a computing device, such as the computing device 102, to allow energy within the waveguide 370 into the upper cavity 320.

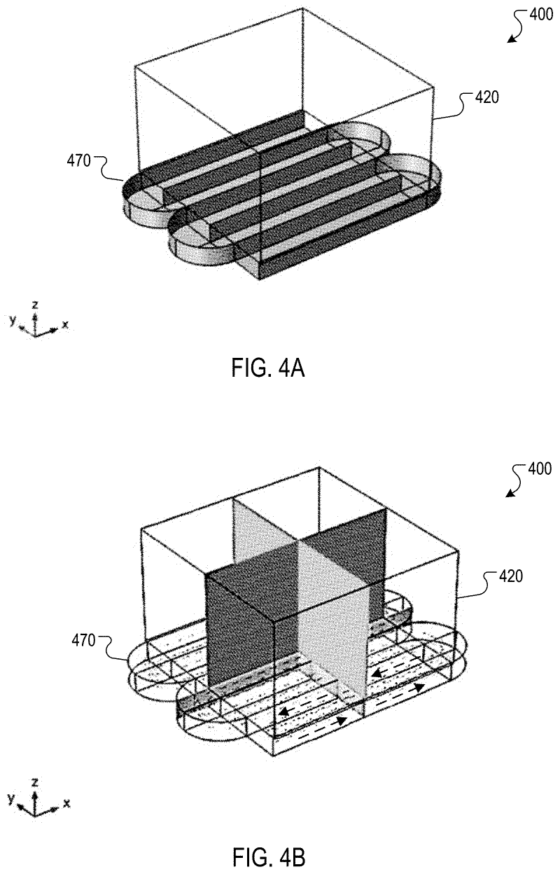

FIG. 4A shows an example cooking device 400 having substantially the same components as the cooking device 300 illustrated in FIGS. 3A and 3B, with the difference that the waveguide 470 has a substantially curved shape to facilitate the energy passing in opposite directions on the x-y plane (e.g., under the food and the aperture), as shown by the arrows in FIG. 4B, instead of passing substantially in the same direction (e.g., from the input port to the output pot, as illustrated in FIG. 3B). Specifically, the energy can pass through the curved waveguide 470 (e.g., under the food and the aperture) multiple times, which can facilitate a single RF power source delivering localized power (e.g., through an aperture) anywhere in the cavity 420.

In some implementations, the waveguide 470 is configured along two or more sides (e.g., a side or top) of the cavity 420. For example, the waveguide 470 can guide energy along a route in one or more of the xy plane, the yz, or zx planes. Apertures can be configured along a waveguide path to allow for heating in the cavity 420 at the locations of the apertures. In some implementations, waveguides extending along one or more sides of a heated item provide efficient heating with reduced heating differences between portions of a heated item compared to single side waveguide or single energy source emission in a heating chamber.

This implementation can further include one or multiple apertures positioned between the waveguide 470 and the cavity 420, to facilitate coupling of energy from the waveguide 470 to the food placed inside the cavity 420. For example, the apertures can include physical disks, each having a pattern of open holes such that a relative rotation of the disks can be used to dynamically open and close individual apertures (e.g., holes) at multiple locations with respect to the food. In some implementations, the waveguide 470 can include multiple frequencies so as to generate a beat frequency and to facilitate the coupling of energy to the food.

As described above, in all implementations of the cooking device of the present disclosure, the one or more apertures can be implemented as “pixels”, e.g., individual elements with properties that can allow for a selective and/or modifiable amount of energy to be transmitted (e.g., coupled) to the food. Generally, by using the pixels, the energy can be modified through interference, absorption, reflection, transmission, physical movement, and/or in any other appropriate manner. In one example, the pixels can be implemented as field-effect transistors (FETs). The reflective (or shielding) properties of such pixels can be modulated through the application (or removal) of voltage, allowing for a highly-customizable coupling between the energy generated by the power generation means and the food. The application (or removal) of voltage by a device, such as the computing device 102, to a FET can adjust a shielding of a corresponding aperture to allow for customizable heating of portions of a heating chamber.

In another example, the FETs and one or more semiconductors in combination can facilitate the application of voltage (e.g., gate voltage) so as to adjust an electron density and thereby adjust the extent to which each of the FETs is able to reflect microwaves. Each of the pixels can be made from a material having desirable properties, e.g., durability under heat cycling and cost. For example, the modulation of gate voltage can control the metal-insulator transition, and thus the sheet resistance, in vanadium oxide thin films, or any other appropriate material. In another example, the modulation of gate voltage can control the electrostatic doping, and thus the sheet resistance, of graphene, or any other single-layered or multi-layered film. Example materials are described with reference to: Yu, Shifeng, et al., “A metal-insulator transition study of VO2 thin films grown on sapphire substrates,” Journal of Applied Physics 122, no. 23 (2017): 235102; and Gao, Min, et al., “Terahertz transmission properties of vanadium dioxide films deposited on gold grating structure with different periods,” Materials Research Express 7, no. 5 (2020): 056404.

In another example, the cooking device can further include an array of coils or patch antennas that are FET addressable. The lower cavity of the cooking device can include, e.g., a standard circuit board (e.g., 2400/5000/900 MHz) and a further multilayer circuit board can be included to facilitate the pixels being FET addressable in the x-y plane. The cooking device can further include substantially electrically-small antennas built into the wall of one or more of the cavities that can be, e.g., substantially grounded, but controllably open circuited as near-field energy sources to facilitate localized and selective coupling of energy to the food. The cooking device can further include an RF multiplexer matched to, e.g., 100 individual electrically-small antennas. The cooking device can further include RF metamaterials for subwavelength focusing.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which can also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program can, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A cooking device, comprising:
a cavity;
one or more waveguides coupled to the cavity;
a power generation means coupled to the one or more waveguides and configured to generate an incident power;
one or more apertures disposed between the cavity and the one or more waveguides, wherein the apertures are configured to modulate an amount of the incident power that is transmitted between the cavity and the waveguide; and
a controller configured to control the power generation means and the apertures.

2. The device of claim 1, where the apertures comprise physical elements for opening and closing a path between the cavity and the one or more waveguides.

3. The device of claim 2, wherein the physical elements comprise field-effect transistors (FETs).

4. The device of claim 3, wherein shield properties of the apertures are modulated by an application or removal of voltage.

5. The device of claim 2, wherein the physical elements include a physical disk having a pattern of open holes configured to dynamically open or close one or more apertures.

6. The device of claim 1, further comprising:
an absorber coupled to the one or more waveguides configured to transform radiation of the incident power into electric energy.

7. The device of claim 6, wherein the absorber includes one or more of antennas, rectifiers, or circuits.

8. The device of claim 6, wherein the absorber includes a network of fluid channels.

9. The device of claim 1, wherein the one or more waveguides are coupled to the cavity on a single side of the cavity.

10. The device of claim 1, wherein the one or more waveguides are coupled to the cavity on two or more sides of the cavity.

11. The device of claim 10, wherein the two or more sides include a first side and a second side, wherein the first side and the second side each lie in a plane and the planes are substantially parallel to one another.

12. The device of claim 1, wherein the incident power comprises microwave radiation.

13. The device of claim 12, wherein the microwave radiation includes multiple electromagnetic frequencies.

14. The device of claim 13, wherein the multiple electromagnetic frequencies are configured to generate a beat frequency and to facilitate coupling of energy to an item to be heated located in the cavity.

15. A method comprising:
obtaining, by a computing device coupled to a cooking device, sensor data from one or more sensors of the cooking device;
generating, using the sensor data, a signal configured to activate one or more apertures of the cooking device, wherein each aperture of the one or more apertures is configured to modulate energy transfer from a first cavity to a second cavity; and
sending the signal to the one or more apertures of the cooking device.

16. The method of claim 15, wherein the first cavity is coupled to a power source generating radiation.

17. The method of claim 15, wherein the sensor data represents data of an item to be heated in the cooking device.

18. The method of claim 15, wherein the one or more sensors of the cooking device include one or more of a weight sensor or thermal sensor.

19. A system, comprising:
one or more processors; and
machine-readable media interoperably coupled with the one or more processors and storing one or more instructions that, when executed by the one or more processors, perform operations comprising:
obtaining, by a computing device coupled to a cooking device, sensor data from one or more sensors of the cooking device;
generating, using the sensor data, a signal configured to activate one or more apertures of the cooking device, wherein each aperture of the one or more apertures is configured to modulate energy transfer from a first cavity to a second cavity; and
sending the signal to the one or more apertures of the cooking device.

20. The system if claim 19, wherein the apertures are disposed between the first cavity and the second cavity along one or more waveguides.
